(19) United States
(12) Patent Application Publication
(10) Pub. No.: US 2026/0122360 A1
(43) Pub. Date: Apr. 30, 2026

(54) PIXEL SHIFTER FOR PRECISE OPTICAL IMAGE STITCHING

(71) Applicant: Shi-Hwa Huang, New Taipei City (TW)

(72) Inventor: Shi-Hwa Huang, New Taipei City (TW)

(21) Appl. No.: 18/933,519

(22) Filed: Oct. 31, 2024

(51) Int. Cl. H04N 23/95; H04N 23/55

(52) U.S. Cl. CPC H04N 23/95; H04N 23/55

(57) ABSTRACT

The present invention relates to a pixel shifter that can segment and deflect an incident light beam of an image. The pixel shifter comprises a plurality of shift units arranged adjacently, which includes an incident layer, an intermediate layer, and an exit layer, disposed from top to bottom. With an upper inclined surface on the incident layer and a lower inclined surface on the exit layer, an incident light beam entering the shift unit can exit as an outgoing light deflected by a certain displacement amount relative to the optical axis of the incident light beam. A plurality of image sensors may be configured correspondingly at a calculated position to receive the image segmented and deflected by the pixel shifter. Through precisely stitching the segmented images, a high-resolution and complete optical image is obtained.

### BACKGROUND OF THE INVENTION

### 1. Field of the Invention

The present invention relates to a pixel shifter, particularly a pixel shifter applied in photographic equipment, projection devices, and telescope systems to enable precise optical image stitching.

### 2. The Prior Arts

In recent years, due to the rapid development of digital devices and advancements in semiconductor technology, there has been an increasing demand for capturing or playing high-resolution digital images. For instance, the CMOS sensors in smartphone cameras can now reach resolutions of up to 64M (9248×6944), while projectors are capable of True 4K (3840×2160) resolution. However, the pursuit of resolution remains unending; many industrial, defense, and scientific applications still require cameras or projectors with even higher resolutions. Traditionally, to capture an extremely high-resolution image with a camera, one would need to segment the area and simultaneously capture photos using multiple lower-resolution cameras, then stitch these images together through software. This approach has a critical drawback: slow image processing, along with visible seams or inconsistencies due to potential misalignment or focus issues among the different cameras. Similarly, in projection systems, achieving very high-resolution images typically involves segmenting the area and projecting with multiple low-resolution projectors, then combining the images. This method also has a major disadvantage: it often results in visible shadows along the seams or, in cases where these shadows are cropped to lose some crucial information (e.g., missing star data in cosmic nebula photos due to segmentation), which is a frequent issue.

For large-scale reflective space telescopes, the size of the primary mirror is closely related to resolution. Given current demands, these mirrors often reach diameters of several meters, with polishing precision required at the nanometer level. This makes the production of ultra-large, highly precise optical mirrors an extremely challenging task. Traditionally, the solution has been to use multiple smaller primary mirrors and arrange them in a mosaic pattern. For instance, small primary mirrors are often shaped as hexagons, with seven, nineteen, or even more mirrors assembled. However, this mosaic arrangement needs gaps conserved between each primary mirror to account for thermal expansion, contraction, and mechanical support. These gaps often cause visible artifacts, such as diffraction patterns that produce six-pointed star-like flares, blocking some regions that could otherwise be observed. Conventional telescopes thus require post-processing to mitigate these effects, which increases processing complexity and labor costs, leading to various drawbacks.

### SUMMARY OF THE INVENTION

One of the objectives of the present invention is to provide a pixel shifter capable of segmenting images from imaging devices (such as CMOS image sensors or projection display chips) or precision large-scale lenses. The segmented images are then precisely stitched to increase the pixel count of an image by 4 times, 9 times, or even up to 25 times. By eliminating the need for large-sized chips, common semiconductor limitations on chip size are no longer a bottleneck for system resolution. This also enables using multiple smaller lenses to replace a single ultra-large lens, significantly reducing production costs.

Another objective of the present invention is to create a pixel shifter formed by the shift units as a square pillar. The desired pixel shifter can be configured by applying relevant parameters of formulas to segment and deflect images captured by devices such as cameras and projectors. Combined with image sensors corresponding to the pixel shifter, it enables precise, seamless image stitching of deflected images.

To achieve the above object, an embodiment of the present disclosure provides a pixel shifter comprising a plurality of shift units; each of the shift units has an incident layer, an exit layer, and an intermediate layer configured between the incident layer and the exit layer. The incident layer is a light transmissive wedge-shaped structure that may include a top flat surface and an upper inclined surface formed at a predetermined tilt angle relative to a horizontal plane. The exit layer is also a light transmissive wedge-shaped structure that may include a bottom flat surface and a lower inclined surface formed at the same predetermined tilt angle relative to the horizontal plane. The exit layer has an identical structure to the incident layer, disposed apart at a predetermined height below the incident layer so that the top flat and bottom flat surfaces are parallel, and the upper and lower inclined surfaces are also parallel. The refractive index of the exit layer is equal to that of the incident layer. The intermediate layer is configured between the upper inclined surface and the lower inclined surface, with a refractive index greater than or equal to 1 but less than that of the incident layer and the exit layer.

The shift units above are arranged adjacently in a horizontal direction to form the pixel shifter so that when an incident light beam emitting from an image enters the incident layer, passes through the intermediate layer, and exits the exit layer as an outgoing light beam; it will be shifted outward relative to the light axis of the incident light by a predetermined displacement amount; whereby the pixel shifter enables a plurality of image sensors, each positioned correspondingly to the shift unit, to individually receive the deflected outgoing light beam for precisely stitching the image.

In an example of the present disclosure, the intermediate layer may be, but not limited to, an air layer or a soft transparent plastic.

In an example of the present disclosure, the predetermined displacement amount is d, and d may meet the following formula:

$$d = h ( \frac{{n}_{1}}{{n}_{2}} - 1 ) ω ( 1 - {ω}^{2} ) ,$$

where h is the predetermined height, n₁ is the refractive index of the incident layer and the exit layer, n₂ is the refractive index of the intermediate layer, and ω is the predetermined tilt angle.

In an example of the present disclosure, the predetermined tilt angle is ω, and ω may meet the following formula:

$$ω < \frac{{n}_{2} - N A}{{n}_{1}} ,$$

where n₁ is the refractive index of the incident layer and the exit layer, n₂ is the refractive index of the intermediate layer, and NA is the numerical aperture of the optical system of the pixel shifter.

In another example of the present disclosure, the shift units are arranged in an array of N×N rows and columns to form the pixel shifter, wherein N is equal to or greater than 2.

In one aspect of the embodiment, N may be an odd number, and the number of shift units is N²−1. In this case, the pixel shifter further includes a central unit, with a tetrahedral structure having only the top flat surface and the bottom flat surface, disposed at the center of the array.

In an example of the present disclosure, the pixel shifter may further comprise a plurality of image sensors respectively positioned corresponding to each of the shift units, and which can individually receive the deflected outgoing light beam from each of the shift units for image stitching.

In one aspect of the embodiment, the image sensors are respectively positioned corresponding to the shift units and the central unit, which may individually receive the deflected outgoing light beam from each of the shift units for image stitching.

In an example of the present disclosure, the shift units may be arrange in an array of 2×2 rows and columns, and each the image sensor may be positioned at the following vector coordinates: the first image sensor at (d, d), the second image sensor at (−d, d), the third image sensor at (−d, −d), and the fourth image sensor at (d, −d); wherein the image sensor is positioned outwards with a vector displacement D_{N} from a vertical line extending from a center of the four shift units, and meets the following formula:

$${D}_{N} = [ \sqrt{2} d cos \frac{( 2 N - 1 ) π}{4} , \sqrt{2} d sin \frac{( 2 N - 1 ) π}{4} ] ,$$

where N=1, 2, 3, and 4, denoting the first to fourth image sensors, d is the predetermined displacement amount and meets the formula:

$$d = h ( \frac{{n}_{1}}{{n}_{2}} - 1 ) ω ( 1 - {ω}^{2} ) ,$$

h is the predetermined height, n₁ is the refractive index of the incident layer and the exit layer, n₂ is the refractive index of the intermediate layer, and ω is the predetermined tilt angle.

In yet another example of the present disclosure, the shift units are arranged in an array of 3×3 rows and columns, and each the image sensor is positioned at the following vector coordinates: the third image sensor at (−d, −d), the second image sensor at (0, d), the first image sensor at (d, d), the fourth image sensor at (−d, 0); the ninth image sensor at (0, 0), the eighth image sensor at (d, 0), the fifth image sensor at (−d, −d), the sixth sensor at (0, −d), and the seventh image sensor at (d, −d); wherein the image sensor is positioned outwards with a vector displacement D_{N} from a vertical line extending from a center of the nine shift units, and meets the following formula:

$${D}_{N} = [ F ( N ) d cos \frac{N π}{4} , F ( N ) d sin \frac{N π}{4} ] ,$$

where N=1˜9, denoting the first to ninth image sensors, d is the predetermined displacement amount and meets the formula:

$$d = h ( \frac{{n}_{1}}{{n}_{2}} - 1 ) ω ( 1 - {ω}^{2} ) ,$$

h is the predetermined height, n₁ is the refractive index of the incident layer and the exit layer, n₂ is the refractive index of the intermediate layer, ω is the predetermined tilt angle; and the coefficient function F(N) meets the formula:

$$F ( N ) = \frac{1 - {( - 1 )}^{N}}{2} \sqrt{2} + \frac{1 - {( - 1 )}^{N + 1}}{2} .$$

In one aspect of the embodiment, the upper inclined surface and the lower inclined surface may be formed with a micro-prism structure having a plurality of micro-inclined surfaces and micro-vertical surfaces, wherein the angles of the micro-inclined surfaces on both the upper and lower inclined surfaces are identical, and the micro-vertical surfaces are opaque, thereby allowing light to pass only through the micro-inclined surfaces.

In an example of the present disclosure, the shift unit may be a quadrilateral pillar or a hexagonal pillar. In one aspect of the embodiment, the shift unit may comprise two triangular pillar shift units connected to form the quadrilateral pillar shift unit.

In another example of the present disclosure, the shift unit is the hexagonal pillar, and the pixel shifter is formed as a ring by six shift units annularly arranged, wherein the shift units are arranged by a counterclockwise sequence starting from an X axis line extending from the center point of the ring and in the order of N=1 to 6, and a displacement vector D_{N} of each the shift unit relative to the center of the ring meets the formula:

$${D}_{N} = [ d cos \frac{( 2 N - 1 ) π}{6} , d sin \frac{( 2 N - 1 ) π}{6} ] ,$$

Where d is the predetermined displacement amount and meets the formula:

$$d = h ( \frac{{n}_{1}}{{n}_{2}} - 1 ) ω ( 1 - {ω}^{2} ) ,$$

h is the predetermined height, n₁ is the refractive index of the incident layer and the exit layer, n₁ is the refractive index of the intermediate layer, and ω is the predetermined tilt angle.

In one aspect of the embodiment, the pixel shifter may further comprise additional 12 shift units by a total of 18 shift units arranged annularly as a ring to form the pixel shifter, which serves as the primary mirror of an astronomical telescope; the original six shift units are arranged into an inner ring and followed by an outer ring with the additional 12 shift units, wherein, in the outer ring, the shift units are also arranged by a counterclockwise sequence starting from the X axis line and in the order of M=1 to 12, and a displacement vector Dy of each the shift unit relative to the center of the ring meets the formula:

$${D}_{M} = [ G ( M ) d cos \frac{( M - 1 ) π}{6} , G ( M ) d sin \frac{( M - 1 ) π}{6} ] ,$$

where the coefficient function G(M) meets the formula:

$$G ( M ) = \frac{1 - {( - 1 )}^{M}}{2} \times 3 + \frac{1 - {( - 1 )}^{M + 1}}{2} \times ( \sqrt{3} + 2 ) .$$

By employing the present disclosure, imaging devices such as cameras and projectors can segment and deflect captured images. These segmented images can then be received by corresponding image sensors for subsequent precise image stitching, resulting in a significant pixel resolution increase of up to several times the original. Additionally, by employing image segmentation with the pixel shifter, multiple smaller image sensors can replace a larger one and thus significantly reduce equipment costs.

### BRIEF DESCRIPTION OF THE DRAWINGS

Disclosed herein will be apparent to those skilled in the art by reading the following detailed description of a preferred embodiment thereof, with reference to the attached drawings, in which:

FIG. 1 is a schematic diagram showing the shift unit according to an embodiment of the present invention and the optical paths of a light beam passing through it vertically;

FIG. 2 is a schematic diagram showing the optical paths of a light beam passing through the shift unit at an angle of B;

FIG. 3 is a schematic diagram showing the pixel shifter formed by two shift units according to an embodiment of the present invention;

FIG. 4A is an assembly diagram of the pixel shifter with a 2×2 array of the shift units according to an embodiment of the present invention;

FIG. 4B is an exploded view of FIG. 4A;

FIG. 4C is a top view of the incident layer of the pixel shifter with a 2×2 array of shift units;

FIG. 4D is a side view of the pixel shifter with a 2×2 array of shift units;

FIG. 5A shows the combination of image sensors corresponding to the shift unit of the pixel shifter with a 2×2 array of shift units according to an embodiment of the present invention;

FIG. 5B shows the disposed position of image sensors corresponding to the shift unit of the pixel shifter with a 2×2 array of shift units;

FIG. 6 is an assembly diagram of the pixel shifter with a 3×3 array of shift units according to an embodiment of the present invention;

FIG. 7 is an exploded view of the pixel shifter with a 3×3 array of shift units and shows the intermediate layer is an air layer;

FIG. 8A shows the combination of an image received by image sensors corresponding to the shift unit of the pixel shifter with a 3×3 array of shift units;

FIG. 8B shows the disposed position of image sensors corresponding to the shift unit of the pixel shifter with a 3×3 array of shift units;

FIG. 9 is an assembly diagram of the pixel shifter with a 2×2 array of the shift units according to another embodiment of the present invention;

FIG. 10 is an exploded view of FIG. 9 and shows the intermediate layer is an air layer;

FIG. 11 is a side view of FIG. 9;

FIG. 12 shows the disposed position of image sensors corresponding to the shift unit of the pixel shifter with a 4×4 array of shift units;

FIG. 13: shows the disposed position of image sensors corresponding to the shift unit of the pixel shifter with a 5×5 array of shift units;

FIG. 14A is a schematic diagram of the arrangement of the image sensors;

FIG. 14B is a top view of the arrangement of the image sensors;

FIG. 15 is a schematic diagram of the arrangement of the shift units in the form of a hexagonal pillar according to an embodiment of the present invention;

FIG. 16 is a schematic diagram of the arrangement of 18 shift units in the form of a hexagonal pillar according to an embodiment of the present invention;

FIG. 17A is a schematic diagram showing a three-dimensional structure of FIG. 15;

FIG. 17B is a side view of FIG. 17A;

FIG. 18A is a schematic diagram of the pixel shifter applied within an extensive telescope system;

FIG. 18B is a partially enlarged view of the circled section in FIG. 18A;

FIG. 19A is a schematic diagram of optical paths for two sets of light beams (E and B) passing through the pixel shifter;

FIG. 19B is a schematic diagram of optical paths for two sets of light beams (E and B) passing through the pixel shifter according to another embodiment of the present invention;

FIG. 19C is an assembly diagram of the pixel shifter with a 2×2 array of the shift units according to one another embodiment of the present invention;

FIG. 19D is a side view of FIG. 19C;

FIG. 20 is a schematic diagram of the pixel shifter applied within a camera system; and

FIG. 21 is a schematic diagram of the pixel shifter applied within a projector system.

### DETAILED DESCRIPTION OF THE PREFERRED EMBODIMENT

The following description and examples illustrate a preferred embodiment of the present invention in detail. They are used to describe the present invention, not to limit the scope of the present invention.

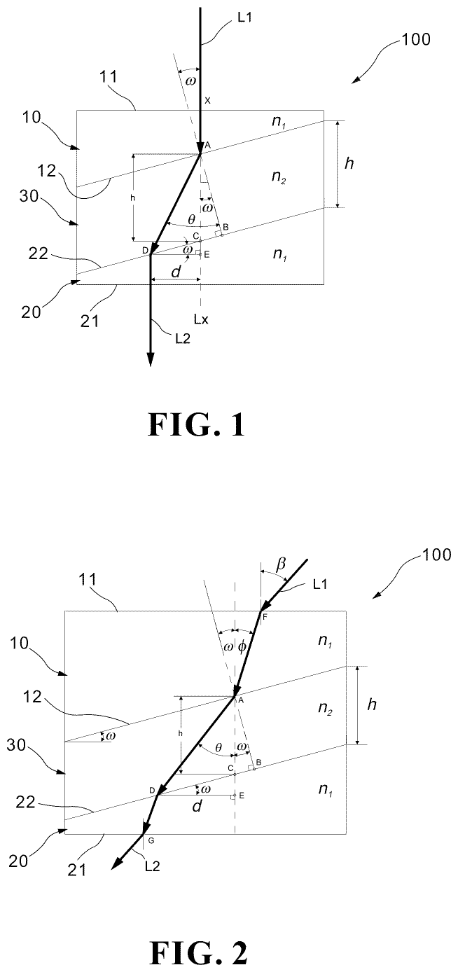

Please refer to FIGS. 1 and 2, which illustrate the basic structure of the shift unit 100 for constituting the pixel shifter. The shift unit 100 has an incident layer 10, an exit layer 20, and an intermediate layer 30, stacked from top to bottom by the sequence of the incident layer 10, the intermediate layer 30, and exit layer 20 and connected to form the shift unit 100. The incident layer 10 is a wedge-shaped structure made of light transmissive material, which includes a top flat surface 11 and an upper inclined surface 12 formed at a predetermined tilt angle ω relative to a horizontal plane. The exit layer 20 is also a wedge-shaped structure made of light transmissive material, which includes a bottom flat surface 21 and a lower inclined surface 22 formed at a predetermined tilt angle ω relative to a horizontal plane. The structures of the incident layer 10 and the exit layer 20 are identical and disposed apart at a height of h. When assembled, the top flat surface 11 and bottom flat surface 21 are parallel, as are the upper inclined surface 12 and lower inclined surface 22. Additionally, the refractive index n₁ of the materials for the incident layer 10 and the exit layer 20 is the same.

The intermediate layer 30 is formed between the upper inclined surface 12 of the incident layer 10 and the lower inclined surface 22 of the exit layer 20. The refractive index n₂ of the intermediate layer 30 is equal to or greater than 1 but less than the refractive index my of the incident layer 10 and the exit layer 20. In this embodiment, the intermediate layer 30 may be, but not limited to, an air layer or a layer of soft transparent plastic. When the intermediate layer 30 is an air layer, several support rods can be positioned between the incident layer 10 and the exit layer 20 using existing manufacturing techniques. Accordingly, as shown in FIG. 1, when an incident light beam L1 (for example, an image light) enters from the incident layer 10, passes through the intermediate layer 30, and exits from the exit layer 20 as an outgoing light beam L2, it will be shifted outward by a displacement amount of d relative to the optical axis Lx of the incident light beam L1. By configuring an image sensor at a corresponding position, the deflected images can be received and detected for subsequent image stitching.

The displacement amount d of the light beam L1 may satisfy the following formula:

$$d = h ( \frac{{n}_{1}}{{n}_{2}} - 1 ) ω ( 1 - {ω}^{2} ) , \qquad ( 1 )$$

where h is the thickness (or height) of the intermediate layer 30, n₁ is the refractive index of the incident layer 10 and the exit layer 20 (e.g., glass), n₂ is the refractive index of the intermediate layer 30 (e.g., air or transparent plastic), and ω is the tilt angle of the upper inclined surface 12 and the lower inclined surface 22 relative to a horizontal plane like the plane parallel to the top flat surface 11 or bottom flat surface 21.

Referring to FIG. 2, this figure considers the light beam L1 that enters the incident layer 10 at a non-perpendicular angle of β. When the incidence angle β is beyond a certain angle, total internal reflection may occur at point A. In this case, the range of tilt angle (ω) of the upper inclined surface 12 and the lower inclined surface 22 relative to a horizontal plane must satisfy the following formula:

$$ω < \frac{{n}_{2} - β}{{n}_{1}} , \qquad ( 2 )$$

where the value of β corresponds to the numerical aperture (NA) of the optical system and the tilt angle ω may be rewrite as the following formula:

$$ω < \frac{{n}_{2} - N A}{{n}_{1}} . \qquad ( 3 )$$

Assuming an optical system with the following parameters: NA=0.33, n₁=1.713 (e.g., optical glass), and n₂=1 (e.g., air), according to formula (3), the value of ω can be calculated to be less than 22.42°. Thus, the tilt angles of the upper inclined surface 12 and the lower inclined surface 22 are preferable to be less than 22.42° to avoid total internal reflection.

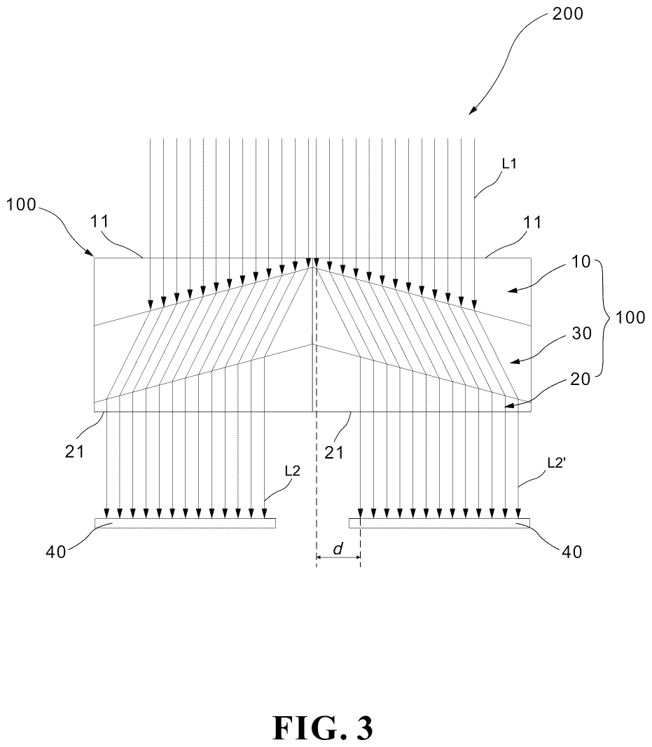

Please refer to FIG. 3, which illustrates an embodiment of a pixel shifter 200 composed of two shift units 100. When an incident light beam L1 (such as an image light) directly enters the pixel shifter 200, it is segmented and deflected in different directions, forming two outgoing light beams L2 and L2′. These outgoing light beams L2 and L2′ are then received respectively by two corresponding image sensors 40. Since the displacement amount d can be calculated as described in formula (1), the two image sensors 40 can be positioned appropriately to receive and detect the full segmented image. These images are subsequently stitched together to produce a clear and complete image.

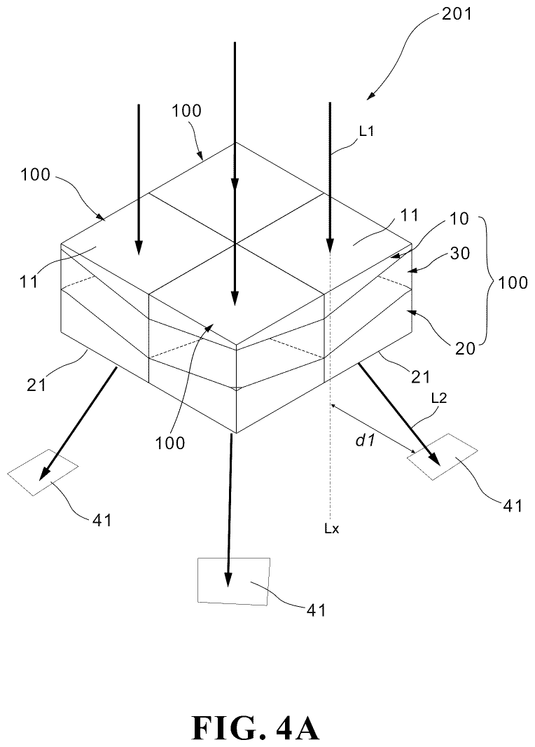

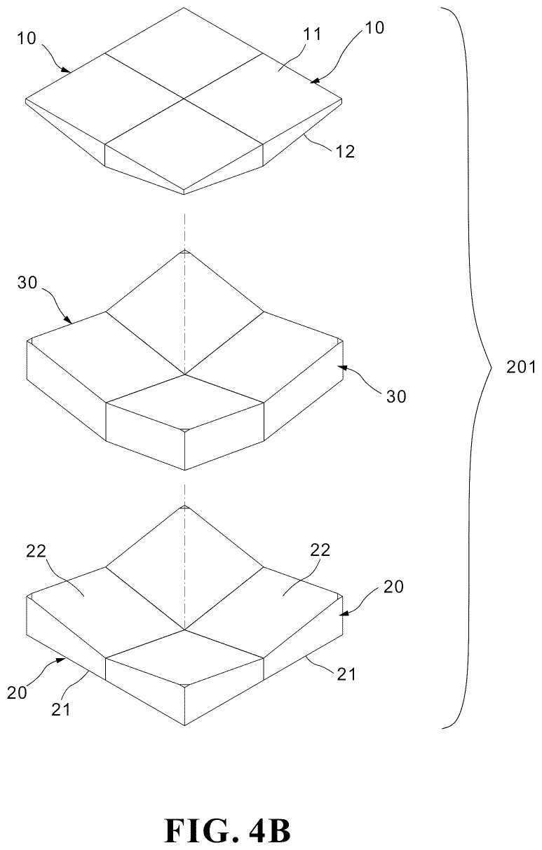

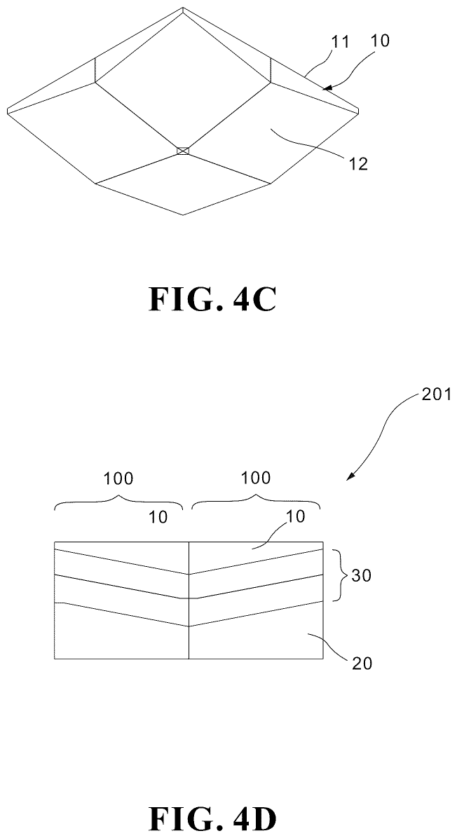

Please refer to FIGS. 4A, 4B, 4C, and 4D, which illustrate an embodiment of the pixel shifter 201 of the present invention, configured in a 2×2 array of shift units 100. From the exploded view in FIG. 4B, it can be seen that in the assembled pixel shifter 201, the top flat planes 11 of the incident layers 10 of each shift unit 100 form a contiguous plane, and likewise, the bottom flat planes 21 of the exit layers 20 also form a contiguous plane. Each intermediate layer 30 is disposed in the space between the incident layer 10 and the exit layer 20. In this embodiment, each of the upper inclined surface 12 or lower inclined surface 22 is tilted toward the center of the pixel shifter 201, forming inclined planes, with no step discontinuities at the connections between the upper inclined surfaces 12 or between the lower inclined surfaces 22. Thus, the upper and lower surfaces of the intermediate layer 30 also form inclined planes that tilt toward the center of the pixel shifter 201. In addition, in this embodiment, the intermediate layer 30 can be made of soft plastic with a refractive index greater than 1; it may include, but not limited to, an air layer or any material with a refractive index greater than or equal to 1.

Accordingly, when a light beam L1 of an image enters through the incident layer 10, passes through the intermediate layer 30, and exits from the exit layer 20 as an outgoing light beam L2, which is deflected outward by a displacement amount of d1 relative to the optical axis Lx of the incident light beam L1. The displacement amount d1 can be further calculated to determine the optimal positioning of the image sensor 41 (see below) to receive the deflected image. Subsequently, the images obtained by the image sensor 41 can be processed and assembled via software to stitch together a complete full image.

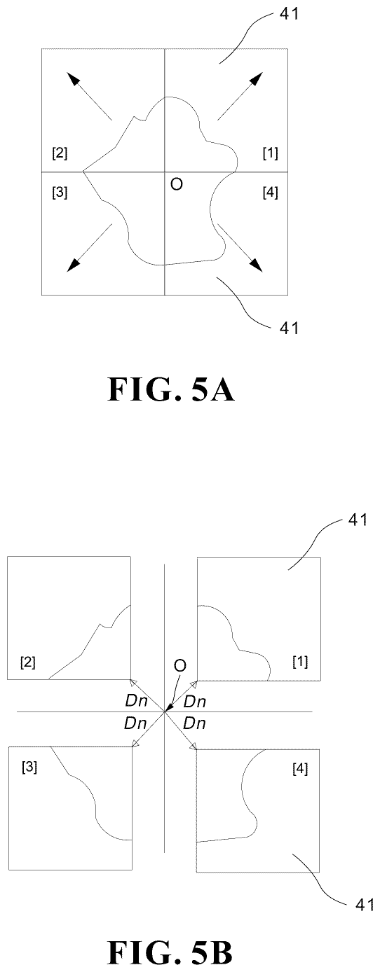

Please refer to both FIGS. 5A and 5B, which show schematic diagrams of the positions of the image sensors 41 relative to the pixel shifter 201. FIG. 5B illustrates the image received (or segmentation) after displacement of the original pattern shown in FIG. 5A. In this embodiment, the shift units 100 form a 2×2 array, assuming the center of the pixel shifter 201 is at the O point, and the X and Y axes extend from the O point. The image sensors 41 are then disposed in the following vector positions: the first sensor is at (d, d), the second sensor at (−d, d), the third sensor at (−d, −d), and the fourth sensor at (d, −d). The displacement vector D_{N} of each image sensor 41 from the center point O satisfies the following formula:

$${D}_{N} = [ \sqrt{2} d cos \frac{( 2 N - 1 ) π}{4} , \sqrt{2} d sin \frac{( 2 N - 1 ) π}{4} ] , \qquad ( 4 )$$

where N=1˜4, denoting the first to fourth image sensors, dis the displacement amount (d1) of the outgoing light beams L2 in the one-dimensional scenario and meets the formula (1).

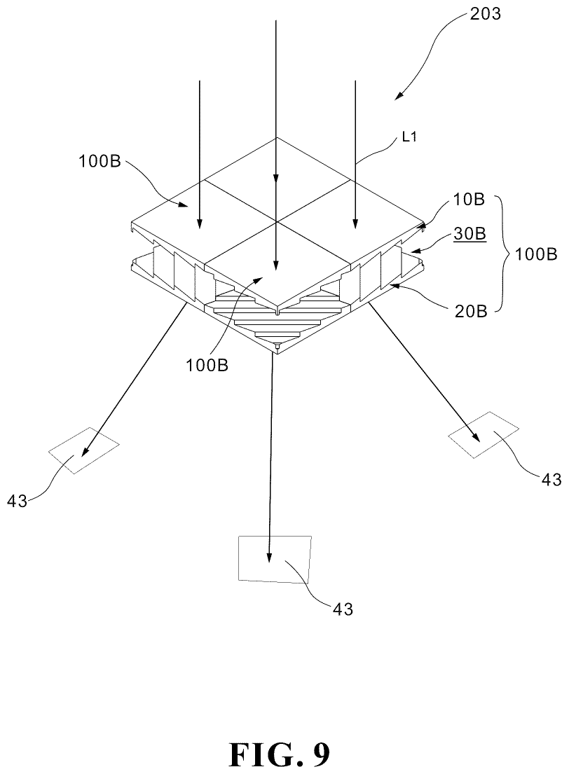

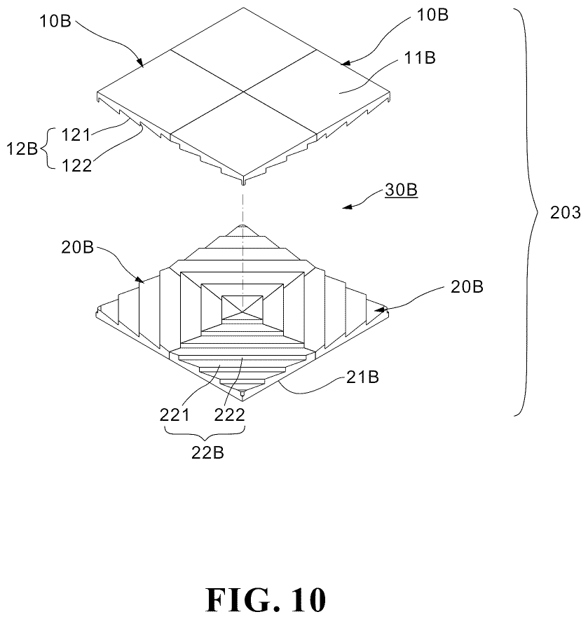

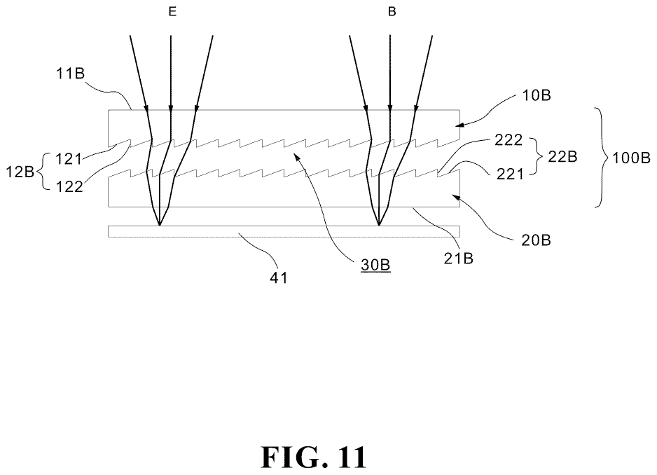

To further refine the pixel shifter of the present invention by reducing its thickness, please refer to FIGS. 9, 10, and 11, a micro-prism pixel shifter 203 is provided. The upper inclined surface 12B of each incident layer 10B may be configured as a plurality of upper micro-inclined surfaces 121 and upper micro-vertical surfaces 122, while the lower inclined surface 22B of each exit layer 20B may be configured as a plurality of lower micro-inclined surfaces 221 and lower micro-vertical surfaces 222. These surfaces undergo micro-prism treatment while maintaining parallel alignment between the micro-prism structures of the upper inclined surface 12B and lower inclined surface 22B. The upper micro-vertical surfaces 122 and lower micro-vertical surfaces 222 are treated to be opaque, for example, by blackening, allowing only the upper micro-inclined surfaces 121 and lower micro-inclined surfaces 221 to transmit light. This configuration enables the light beam, whether E or B, to be deflected by a displacement amount while significantly reducing the thickness, weight, and volume of each shift unit 100B in the pixel shifter 203, benefiting storage, transport, and cost savings.

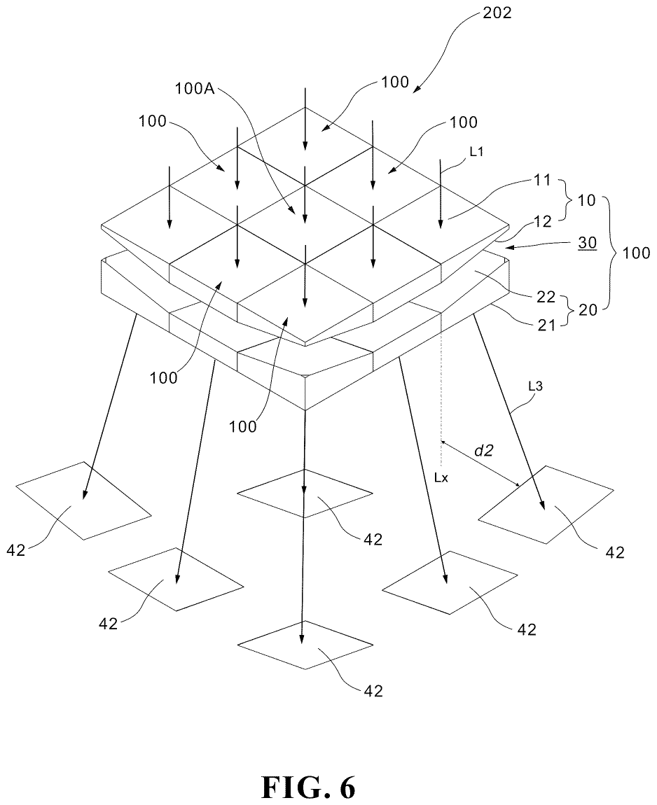

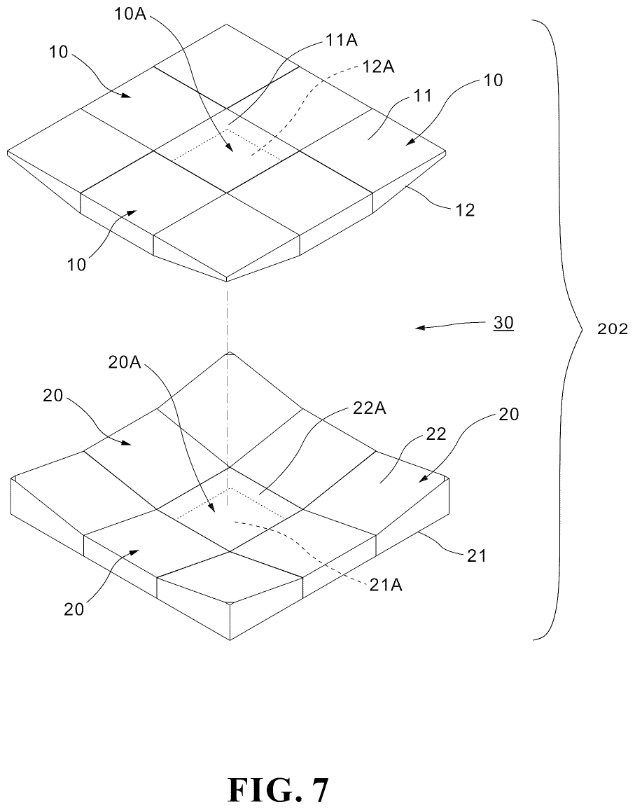

In another embodiment of the present invention, as illustrated in FIGS. 6 and 7, a pixel shifter 202 configured in a 3×3 array composed of eight shift units 100 and one central unit 100A is provided. The central unit 100A, located at the array's center, includes only an incident layer 10A with a top flat surface 11A and an exit layer 20A with a bottom flat surface 21A. Unlike the shift unit 100, the upper inclined surface 12A and lower inclined surface 22A are flat configured rather than inclined. As shown in the exploded view in FIG. 7, the top flat surfaces 11 of the incident layer 10 of the shift unit 100 and the top flat surface 11A of the central unit 100A form a contiguous plane. Similarly, the bottom flat surfaces 21 of the exit layers 20 and the bottom flat surface 21A of the central unit 100A form a contiguous plane. Each intermediate layer 30 is a structure formed by the space between the incident layer 10, 10A and the exit layer 20, 20A. In this embodiment, both the upper inclined surfaces 12 and the lower inclined surfaces 22 of the shift unit 100 tilt toward the center of the pixel shifter 202, with no steps at the connections between these inclined surfaces. Thus, except for the central unit 100A, the upper and lower surfaces of each intermediate layer 30 form inclined planes that tilt toward the center of the pixel shifter 202. In this embodiment, the intermediate layer 30 is an air layer with a refractive index of 1; it may include, but not limited to, soft plastic or any material with a refractive index greater than or equal to 1.

Accordingly, when the image light beam L1 enters through the incident layers 10 or 10A, passes through the intermediate layer 30, and exits from the exit layers 20 or 20A as an outgoing light beam L3, which, except for that passing the central unit 100A, is deflected outward by a displacement vector d2 relative to the optical axis Lx of the incident light beam L1. The displacement amount d2 can be further calculated to determine the optimal positioning of the image sensor 42 (see below) to receive the deflected image. Subsequently, the images obtained by the image sensor 42 can be processed and assembled via software to stitch together a complete full image.

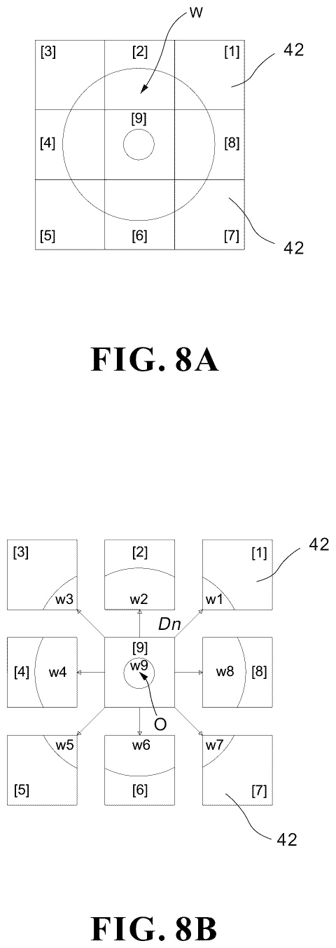

Please refer to both FIGS. 8A and 8B simultaneously, which show schematic diagrams of the positions of the image sensors 42 relative to the pixel shifter 202. FIG. 8B illustrates the image w1 to w8 received (or segmentation) after displacement of the original pattern W shown in FIG. 8A. In this embodiment, eight shift units 100 and one central unit 100A form a 3×3 array, assuming the center of the pixel shifter 202 is at the O point and the X and Y axes extend from the O point. The image sensors 42 are then disposed counterclockwise in the following vector positions: the third sensor at (−d, −d), the second sensor at (0, d), the first sensor at (d, d), the fourth sensor is at (−d, 0), the ninth sensor at (0, 0), the eighth sensor at (d, 0), the fifth sensor is at (−d, −d), the sixth sensor at (0, −d), and the seventh sensor at (d, −d). The displacement vector D_{N} of each image sensor 42 from the center point O satisfies the following formula:

$${D}_{N} = [ F ( N ) d cos \frac{N π}{4} , F ( N ) d sin \frac{N π}{4} ] , \qquad ( 5 )$$

where N=1˜9, denoting the first to ninth image sensors, dis the displacement amount (d2) of the outgoing light beams L3 in the one-dimensional scenario and meets the formula (1), and the coefficient function F(N) meets the formula:

$$F ( N ) = \frac{1 - {( - 1 )}^{N}}{2} \sqrt{2} + \frac{1 - {( - 1 )}^{N + 1}}{2} . \qquad ( 6 )$$

Through this embodiment according to the present invention, a larger image sensor chip (like the size of all image sensor 42 shown in FIG. 8A) can be replaced by a smaller-sized image sensor chip (like the single image sensor 42), significantly reducing the equipment cost.

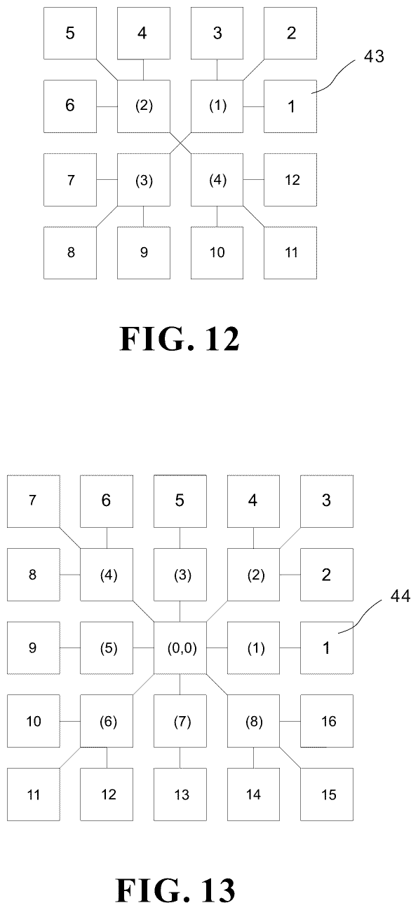

Additionally, referring to FIG. 12, if the pixel shifter is arranged in an even-numbered N×N array, the positioning of the corresponding image sensors can be divided into N/2 inner rings. In this embodiment, the corresponding 4×4 array of image sensors 43 are configured in two inner rings. In this case, the vector position of the first inner ring is at (±d, ±d), and the vector position of the second inner ring is at (±2d, ±2d). However, as shown in FIG. 13, if the pixel shifter is arranged in an odd-numbered N×N array, the positioning of the image sensors can be divided into (N+1)/2 inner rings. As shown in FIG. 13, when N=5, the positioning of the corresponding image sensors 44 can be configured in three inner rings. The vector position of the first inner ring is at (0,0), the second inner ring is at (±d, ±d), and the third inner ring is at (±2d, ±2d). As the demand for pixels increases, the value of N can be adjusted accordingly, and the corresponding image sensors are arranged similarly.

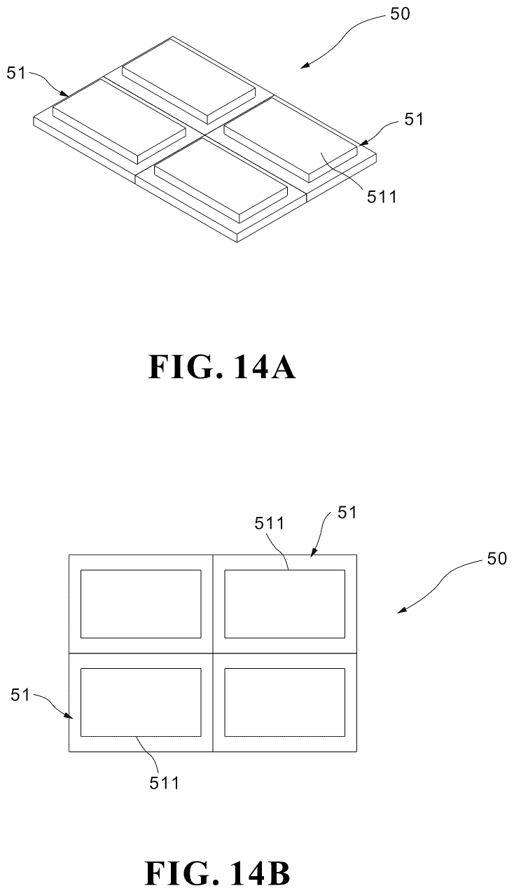

The following describes the application of pixel enhancement using the pixel shifter according to an embodiment of the present invention. Refer to FIGS. 14A and 14B, where four conventional image sensors 51 are arranged adjacently to form an image sensor group 50, and the effective pixel area 511 thereof represents the region capable of receiving images. Assuming each image sensor 51 has a pixel count of 1920×1080 pixels, with an image area of 5808 μm×3288 μm, a packaging area of 6956 μm×4765 μm, and an image equivalent size of 1/2.7 inch, then by using the pixel shifter of a 2×2 array according to the present invention, and configuring the image sensors 51 in appropriate positions calculated by previous formulas to form the image sensor group 50. Accordingly, the source image is segmented and deflected into the effective pixel area 511 of each image sensor 51. By stitching the images obtained by each sensor 51, a complete image with four times the original pixel quality can be achieved. The enhanced image has parameters as follows: pixel count of 3840×2160 pixels, an image area of 13342 μm×8196 μm, a packaging area of 14384 μm×9673 μm, and an image equivalent size of 1 inch (13.2×8.8 mm). Thus, using the pixel shifter according to the present invention configured with the corresponding image sensors allows seamless image stitching while achieving a fourfold increase in pixel count, providing significant progress in overcoming bottlenecks related to structure setup and costs.

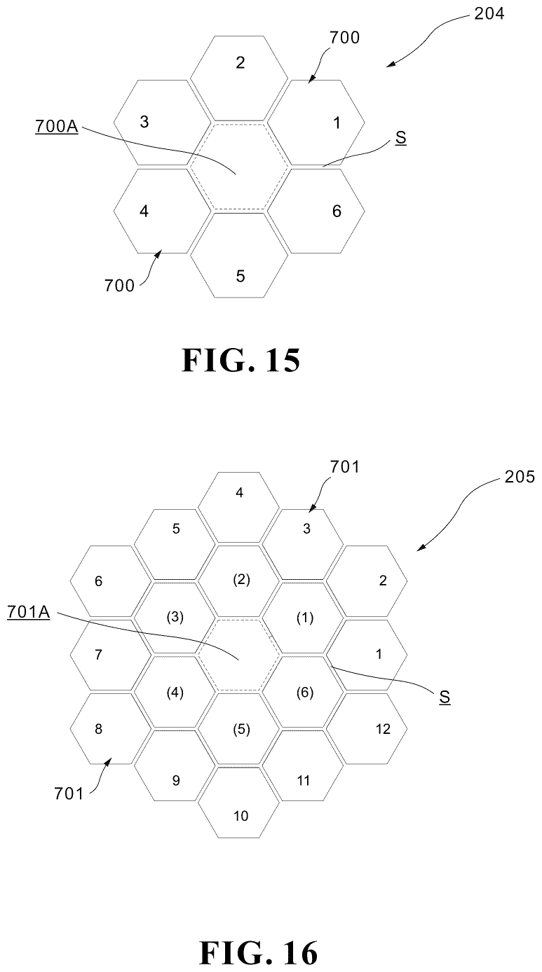

The pixel shifter of the present invention can also be applied to the primary mirror of astronomical telescopes. In telescopes, the larger the primary mirror, the higher the resolution. However, manufacturing huge, high-precision mirrors is very costly. Typically, the primary mirror is assembled from multiple mirrors, and using nearly circular hexagonal mirrors for this assembly is the most effective method. As shown in FIG. 15, in this embodiment, the pixel shifter 204—serving as the mirror—comprises six hexagonal shift units 700 arranged in a circle, expanding the total receptive area by six times. The center of the pixel shifter 204 has a light-transmitting hole 700A.

Similarly, as shown in FIG. 16, another configuration of the pixel shifter 205 is formed by eighteen shift units 701, which can expand the receptive area by 18 times. The center of the pixel shifter 205 is also a light-transmitting hole 701A. In addition, gaps S conserved are necessary between adjacent shift units 700 or 701 to prevent collisions or friction. However, gaps S in conventional mirror assemblies often result in a loss of image reception. By using the pixel shifter according to the present invention instead of traditional mirrors, this issue can thus be overcome.

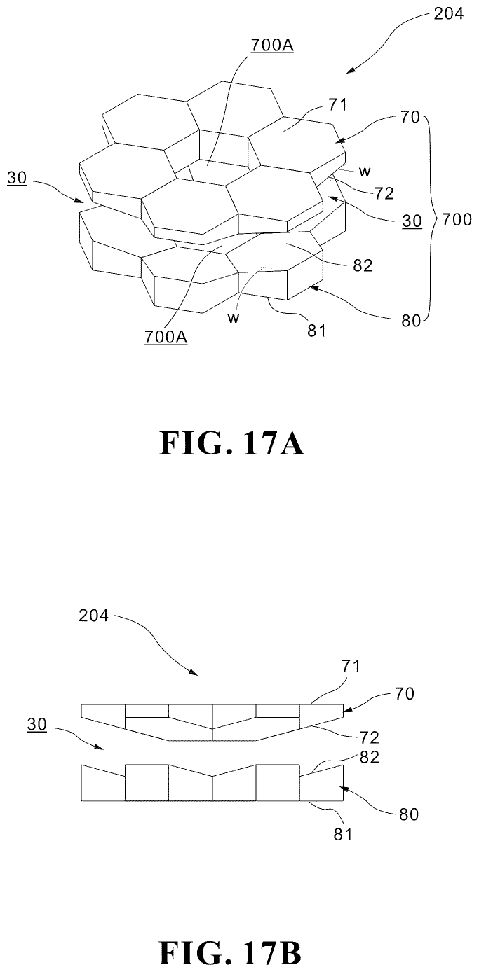

Please refer to FIGS. 17A and 17B. In an embodiment where the pixel shifter 204 of the present invention is applied to a space telescope as a primary mirror, it includes six shift units 700 in the form of a hexagonal pillar. The structure of each shift unit 700 is generally the same as that of the shift units described previously. The shift unit 700 has an incident layer 70, an exit layer 80, and an intermediate layer 30, stacked from top to bottom by the sequence of the incident layer 70, the intermediate layer 30, and exit layer 80 and connected to form the shift unit 700. The incident layer 70 is made of light transmissive material, which includes a top flat surface 71 and an upper inclined surface 72 formed at a predetermined tilt angle w relative to a horizontal plane. The exit layer 80 is also made of light transmissive material, which includes a bottom flat surface 81 and a lower inclined surface 82 formed at a predetermined tilt angle w relative to a horizontal plane. The structures of the incident layer 70 and the exit layer 80 are identical and disposed apart at a height of h. When assembled, the top flat surface 71 and bottom flat surface 81 are parallel, as are the upper inclined surface 72 and lower inclined surface 82. Additionally, the refractive index of the materials for the incident layer 70 and the exit layer 80 is the same.

Please refer to FIG. 15, which illustrates the application of the pixel shifter as the primary mirror of an astronomical telescope. Using the central point of the pixel shifter 204 as a reference, the shift units 700 are arranged counterclockwise and annularly in sequence with N=1 to 6 to form the pixel shifter 204 as a ring from an X axis line extending from the center point of the ring. The displacement vector D_{N} for the positioning of each shift 700 from the center of the ring may satisfy the following formula:

$${D}_{N} = [ d cos \frac{( 2 N - 1 ) π}{6} , d sin \frac{( 2 N - 1 ) π}{6} ] , \qquad ( 7 )$$

where d is the displacement amount of the outgoing light beams in the one-dimensional scenario and meets the formula (1).

When the pixel shifter 204 of the present invention is applied in a more advanced astronomical telescope, as shown in FIG. 16, it can replace the primary mirror of a giant telescope and is formed by eighteen shift units (mirrors) 701, arranged in both an inner ring and an outer ring. Six shift units 701 are arranged as shift units 700 into an inner ring and followed by an outer ring with the additional 12 shift units 701, wherein, in the outer ring, the shift units 701 are also arranged in a counterclockwise sequence starting from the X axis line and in the order of M=1 to 12, and a displacement vector Dar of each the shift unit 701 relative to the center of the ring may satisfy the formula:

$${D}_{M} = [ G ( M ) d cos \frac{( M - 1 ) π}{6} , G ( M ) d sin \frac{( M - 1 ) π}{6} ] , \qquad ( 8 )$$

where the coefficient function G(M) satisfies the formula:

$$G ( M ) = \frac{1 - {( - 1 )}^{M}}{2} \times 3 + \frac{1 - {( - 1 )}^{M + 1}}{2} \times ( \sqrt{3} + 2 ) . \qquad ( 9 )$$

Accordingly, when the pixel shifter of the present invention is used as the primary mirror in an astronomical telescope, the displacement amount of the image can be calculated in advance, whether for the inner ring displacement vectors or the outer ring displacement vectors. This ensures the pixel shifter (mirror) is positioned optimally to capture the entire image. Therefore, when used in imaging, employing the pixel shifter of the present invention as the mirror will prevent any image loss; namely, there will be no loss of celestial nebula details.

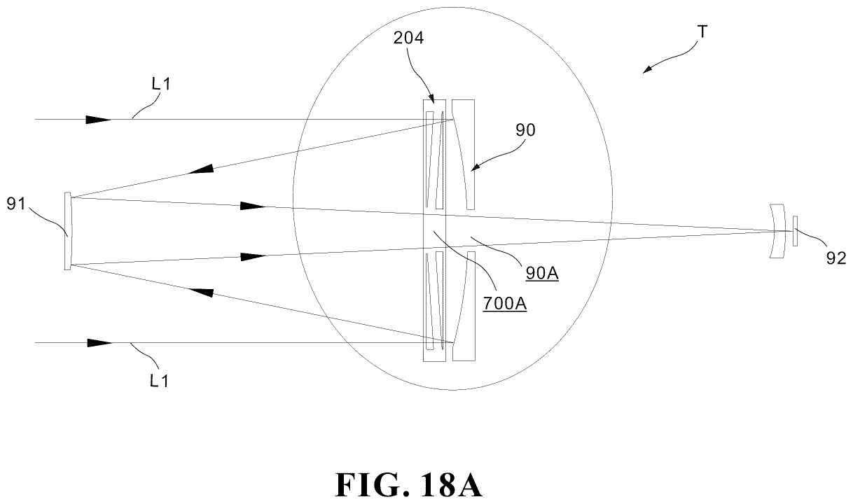

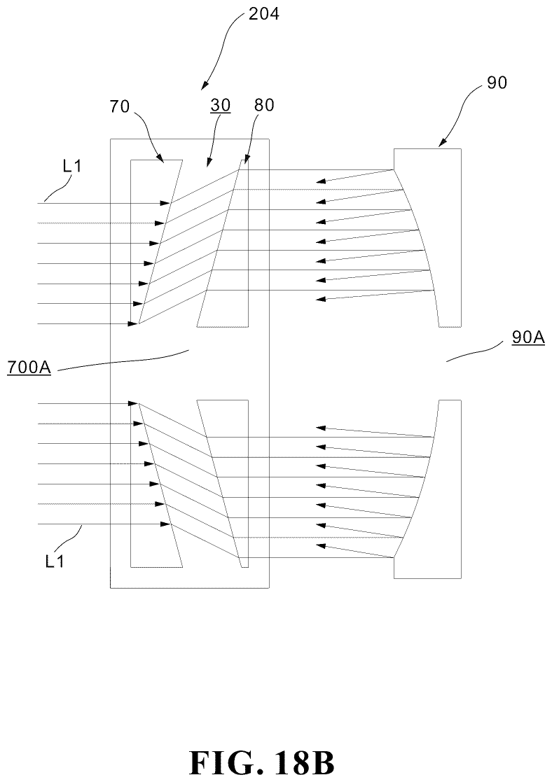

Referring to FIGS. 18A and 18B, where FIG. 18B is an enlarged view of the circled section in FIG. 18A. The telescope T includes a primary mirror 90 with a central aperture 90A. In front of the primary mirror 90 is a secondary mirror 91, and behind the primary mirror 90, aligned with the central aperture 90A, is an image sensor 92. The pixel shifter 204 is positioned in front of the primary mirror 90. When the incident light L1 is directed to the primary mirror 90, it first passes through the pixel shifter 204. The incident light L1 is firstly segmented and deflected, then reflected by the primary mirror 90 to the secondary mirror 91 and finally received by the image sensor 92, resulting in a complete and clear image of celestial nebulae.

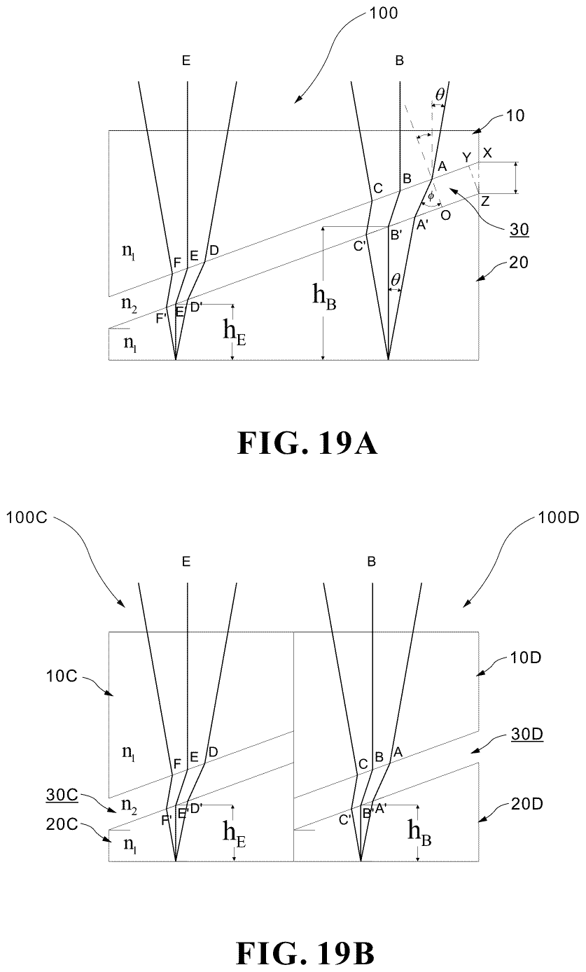

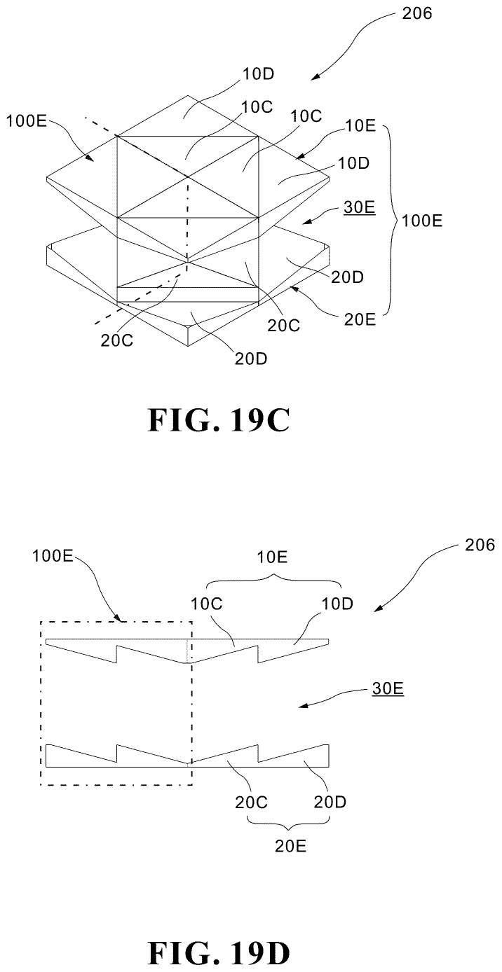

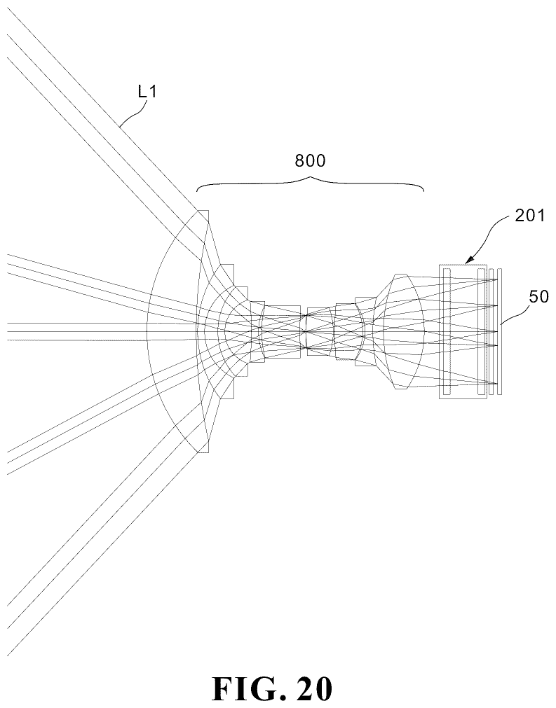

Consider utilizing a larger size of the pixel shifter, as shown in FIG. 19A, when two incident lights, E and B, enter from opposite sides of shift unit 100, they may transmit in different path lengths in the exit layer 20; namely, the value of h_{B} and h_{E} may differ. This could result in uneven aberration, leading to slight image blurring.

To address this concern, refer to FIG. 19C. In the pixel shifter 206, the shift unit 100E is created by dividing the original shift unit 100 shown in FIG. 4B along the diagonal, replacing each original shift unit 100 with two shift units 100E. As a result, the incident layer 10E comprises incident layers 10C and 10D, while the exit layer 20E comprises exit layers 20C and 20D. The incident layers 10C and 10D and the exit layers 20C and 20D are arranged in a sawtooth pattern shown in FIG. 19D so that the value of h_{B}-h_{E} will be zero or close to zero. This embodiment prevents uneven aberration and blurring, reduces the overall thickness, and achieves the advantage of a lighter weight.

Additionally, refer to FIG. 20, the pixel shifter 201 of the present invention may be applied to cameras to increase pixel count. The incident light beam L1 enters through the lens group 800 and is subsequently segmented and deflected by the pixel shifter 201, finally being captured by the image sensor 50. By employing the pixel shifter 201 of the present invention and combining it with four 2M-pixel image sensors, an 8M module can be achieved. Combining four 8M-pixel image sensors results in a 32M module, and combining four 32M-pixel image sensors yields a 128M ultra-high-resolution module. Traditionally, manufacturing a 128M-pixel image sensor is expensive and challenging. However, by utilizing the pixel shifter of the present invention, seamless image stitching can be achieved, forming a parallel processing method that also provides advantageous speed in image processing.

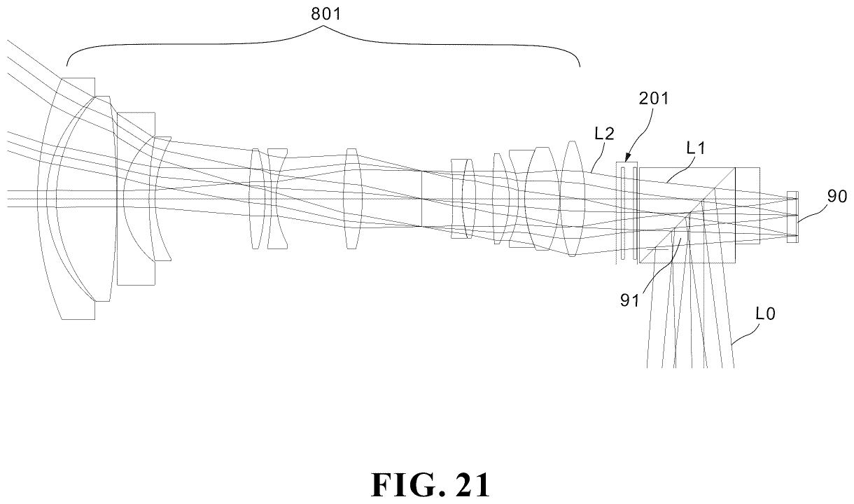

On the other hand, the pixel shifter 201 in this invention may also be applied to projectors to increase their pixel count. Referring to FIG. 21. taking a Liquid Crystal on Silicon (LCOS) panel or a Digital Micromirror Device (DMD) panel as an example, light beam L0 provided by the light source passes through a polarized beam splitter prism 91, where S-polarized light is reflected to the LCOS (or DMD) panel 90 and then reflected; in contrast, P-polarized light is transmitted and refracted. The refracted P-polarized light and the S-polarized light reflected by the LCOS 90 form an incident light beam L1. The incident light beam L1 is segmented and deflected by the pixel shifter 201 as an outgoing beam L2. Then, it passes through the projection lens assembly 801, enabling the projection of a high-resolution image. Using the pixel shifter 201 of the present invention in combination with multiple LCOS or DMD panels, a high-pixel-count projection panel module can be achieved while also providing benefits similar to those when applied to cameras.

Employing the pixel shifter according to the present invention, an optical image can be segmented, deflected, and received by individual corresponding image sensors for subsequent image processing. This enables precise optical image stitching to achieve up to 4×, 9×, or even 25× resolution enhancement. Furthermore, because the image processing method can employ parallel processing, image stitching is time-saving and efficient. Additionally, the pixel shifter may replace a larger image sensor with a plurality of smaller image sensors, thus reducing equipment costs. Moreover, by utilizing an array or polygonal arrangement of shift units to constitute the pixel shifter, the present invention can also segment and stitch segmented images to obtain a complete image, effectively mitigating the gap issues commonly encountered in standard imaging devices and compact primary mirrors.

What is claimed is:

1. A pixel shifter for precise optical image stitching, comprising:
a plurality of shift units, each of the shift units having:
an incident layer being a light transmissive wedge-shaped structure and including a top flat surface and an upper inclined surface formed at a predetermined tilt angle relative to a horizontal plane;
an exit layer being a light transmissive wedge-shaped structure and including a bottom flat surface and a lower inclined surface formed at the same predetermined tilt angle relative to the horizontal plane, wherein the exit layer has an identical structure to the incident layer and is disposed apart at a predetermined height below the incident layer so that the top flat and bottom flat surfaces are parallel, and the upper and lower inclined surfaces are also parallel; and the refractive index of the exit layer is equal to that of the incident layer; and
an intermediate layer configuring between the upper inclined surface and the lower inclined surface, with a refractive index greater than or equal to 1 but less than that of the incident layer and the exit layer;
wherein the shift units are arranged adjacently in a horizontal direction to form the pixel shifter so that when an incident light beam emitting from an image enters the incident layer, passes through the intermediate layer, and exits the exit layer as an outgoing light beam, it will be shifted outward relative to the light axis of the incident light by a predetermined displacement amount; whereby the pixel shifter enables a plurality of image sensors, each positioned correspondingly to the shift unit, to individually receive the deflected outgoing light beam for precisely stitching the image.

2. The pixel shifter according to claim 1, wherein the intermediate layer is an air layer or a soft transparent plastic.

3. The pixel shifter according to claim 1, wherein the predetermined displacement amount is d, and d meets the following formula:
$$d = h ( \frac{{n}_{1}}{{n}_{2}} - 1 ) ω ( 1 - {ω}^{2} ) ,$$
where h is the predetermined height, n₁ is the refractive index of the incident layer and the exit layer, n₂ is the refractive index of the intermediate layer, and ω is the predetermined tilt angle.

4. The pixel shifter according to claim 1, wherein the predetermined tilt angle is ω, and ω meets the following formula:
$$ω < \frac{{n}_{2} - NA}{{n}_{1}} ,$$
where n₁ is the refractive index of the incident layer and the exit layer, n₂ is the refractive index of the intermediate layer, and NA is the numerical aperture of the optical system of the pixel shifter.

5. The pixel shifter according to claim 1, wherein the shift units are arranged in an array of N×N rows and columns to form the pixel shifter, wherein N is equal to or greater than 2.

6. The pixel shifter according to claim 5, wherein N is an odd number, and the number of shift units is N²−1; the pixel shifter further includes a central unit, with a tetrahedral structure having only the top flat surface and the bottom flat surface, disposed at the center of the array.

7. The pixel shifter according to claim 1, further comprising a plurality of image sensors respectively positioned corresponding to each the shift unit, and which can individually receive the deflected outgoing light beam from each the shift unit for image stitching.

8. The pixel shifter according to claim 5, further comprising a plurality of image sensors respectively positioned corresponding to each the shift unit, and which can individually receive the deflected outgoing light beam from each the shift unit for image stitching.

9. The pixel shifter according to claim 6, further comprising a plurality of image sensors respectively positioned corresponding to each the shift unit and the central unit, and which can individually receive the deflected outgoing light beam from each the shift unit for image stitching.

10. The pixel shifter according to claim 7, wherein the shift units are arranged in an array of 2×2 rows and columns, and each the image sensor is positioned at the following vector coordinates: the first image sensor at (d, d), the second image sensor at (−d, d), the third image sensor at (−d, −d), and the fourth image sensor at (d, −d); wherein the image sensor is positioned outwards with a vector displacement D_{N} from a vertical line extending from a center of the four shift units, and meets the following formula:
$${D}_{N} = [ \sqrt{2} d cos \frac{( 2 N - 1 ) π}{4} , \sqrt{2} d sin \frac{( 2 N - 1 ) π}{4} ] ,$$
where N=1, 2, 3, and 4, denoting the first to fourth image sensors, d is the predetermined displacement amount and meets the formula:
$$d = h ( \frac{{n}_{1}}{{n}_{2}} - 1 ) ω ( 1 - {ω}^{2} ) ,$$
h is the predetermined height, n₁ is the refractive index of the incident layer and the exit layer, n₂ is the refractive index of the intermediate layer, and ω is the predetermined tilt angle.

11. The pixel shifter according to claim 8, wherein the shift units are arranged in an array of 3×3 rows and columns, and each the image sensor is positioned at the following vector coordinates: the third image sensor at (−d, −d), the second image sensor at (0, d), the first image sensor at (d, d), the fourth image sensor at (−d, 0); the ninth image sensor at (0, 0), the eighth image sensor at (d, 0), the fifth image sensor at (−d, −d), the sixth sensor at (0, −d), and the seventh image sensor at (d, −d); wherein the image sensor is positioned outwards with a vector displacement D_{N} from a vertical line extending from a center of the nine shift units, and meets the following formula:
$${D}_{N} = [ F ( N ) d cos \frac{N π}{4} , F ( N ) d sin \frac{N π}{4} ] ,$$
where N=1˜9, denoting the first to ninth image sensors, d is the predetermined displacement amount and meets the formula:
$$d = h ( \frac{{n}_{1}}{{n}_{2}} - 1 ) ω ( 1 - {ω}^{2} ) ,$$
h is the predetermined height, n₁ is the refractive index of the incident layer and the exit layer, n₂ is the refractive index of the intermediate layer, ω is the predetermined tilt angle; and the coefficient function F(N) meets the formula:
$$F ( N ) = \frac{1 - {( - 1 )}^{N}}{2} \sqrt{2} + \frac{1 - {( - 1 )}^{N + 1}}{2} .$$

12. The pixel shifter according to claim 1, wherein the upper inclined surface and the lower inclined surface are formed with a micro-prism structure having a plurality of micro-inclined surfaces and micro-vertical surfaces, wherein the angles of the micro-inclined surfaces on both the upper and lower inclined surfaces are identical, and the micro-vertical surfaces are opaque, thereby allowing light to pass only through the micro-inclined surfaces.

13. The pixel shifter according to claim 1, wherein the shift unit is a quadrilateral pillar or a hexagonal pillar.

14. The pixel shifter according to claim 13, wherein the shift unit comprises two triangular pillar shift units connected together to form the quadrilateral pillar shift unit.

15. The pixel shifter according to claim 13, wherein the shift unit is the hexagonal pillar and the pixel shifter is formed as a ring by six shift units annularly arranged, wherein the shift units are arranged by a counterclockwise sequence starting from an X axis line extending from the center point of the ring and in the order of N=1 to 6, and a displacement vector D_{N} of each the shift unit relative to the center of the ring meets the formula:
$${D}_{N} = [ d cos \frac{( 2 N - 1 ) π}{6} , d sin \frac{( 2 N - 1 ) π}{6} ] ,$$
Where d is the predetermined displacement amount and meets the formula:
$$d = h ( \frac{{n}_{1}}{{n}_{2}} - 1 ) ω ( 1 - {ω}^{2} ) ,$$
h is the predetermined height, n₁ is the refractive index of the incident layer and the exit layer, n₂ is the refractive index of the intermediate layer, and ω is the predetermined tilt angle.

16. The pixel shifter according to claim 15, further comprising additional 12 shift units by a total of 18 shift units arranged annularly as a ring to form the pixel shifter, which serves as the primary mirror of an astronomical telescope; the original six shift units are arranged into an inner ring and followed by an outer ring with the additional 12 shift units, wherein, in the outer ring, the shift units are also arranged by a counterclockwise sequence starting from the X axis line and in the order of M=1 to 12, and a displacement vector D_{M} of each the shift unit relative to the center of the ring meets the formula:
$${D}_{M} = [ G ( M ) d cos \frac{( M - 1 ) π}{6} , G ( M ) d sin \frac{( M - 1 ) π}{6} ] ,$$
where the coefficient function G(M) meets the formula:
$$G ( M ) = \frac{1 - {( - 1 )}^{M}}{2} \times 3 + \frac{1 - {( - 1 )}^{M + 1}}{2} \times ( \sqrt{3} + 2 ) .$$
